(19) United States
(12) Patent Application Publication
(10) Pub. No.: US 2009/0279450 A1
(43) Pub. Date: Nov. 12, 2009

(54) METHOD FOR ALLOCATION OF A QUALITY OF SERVICE FOR A PACKET STREAM

(75) Inventors: Rudolf Bitzinger, Muenchen (DE); Christian Prehofer, Muenchen (DE); Viktor Ransmayr, Muenchen (DE)

Correspondence Address: Dickinson Wright, PLLC, 1875 Eye Street, NW, Suite 1200, Washington, DC, 20006, US

(73) Assignee: Nokia Siemens Networks GmbH & Co. KG, Munchen (DE)

(21) Appl. No.: 12/267,335

(22) Filed: Nov. 7, 2008

Related U.S. Application Data
(63) Continuation of application No. 09/936,488, filed on Dec. 26, 2001, now abandoned.

(30) Foreign Application Priority Data
Mar. 10, 1999 (DE) 199 10 585.5

(51) Int. Cl. H04L 12/26

(52) U.S. Cl. 370/253

(57) ABSTRACT

For a service which is provided in at least one communications network preferably an Internet with service classes—which transmits packets and/or packet streams on a packet-oriented basis as a function of Qualities of Service, use of a service is requested with a controller, and this controller allocates a Quality of Service for the requested use as a function of the service and/or of the requested use of the service. A VoIP service implemented in accordance with International Standard H.323 can thus be used with a required Quality of Service.

### BACKGROUND OF THE INVENTION

Modern packet-oriented networks, also referred to as “data networks”, have until now been designed essentially for the transmission of packet streams, which are also referred to in the specialist world as “data packet streams”. In this case, there is normally no need for any guaranteed transmission Quality of Service. The data packet streams are thus transmitted, for example, with fluctuating time delays since the individual data packets in the data packet streams are normally transmitted in the sequence of their network access; that is to say, the time delays become greater the greater the number of packets to be transmitted by a data network. In the specialist world, transmission of data is, therefore, also referred to as a transmission service without any realtime conditions, or as a “non-realtime service”.

In the course of convergence of line-oriented voice and packet-oriented data networks, realtime services, that is to say transmission services subject to the realtime conditions such as the transmission of voice or moving picture information, are likewise increasingly being provided in packet-oriented networks. That is the previously normal realtime services which were transmitted on a line-oriented basis are transmitted in a packet-oriented manner, or in packet streams, in a convergent voice/data network. These are also referred to as “realtime packet streams”. This results in the problem that a high Quality of Service is required for packet-oriented transmission of a realtime service whose quality is comparable to that when using line-oriented transmission. In particular, a minimal, for example <200 ms, delay without any fluctuations in the delay time is important, since realtime services generally require a continuous information flow and any loss of information, such as that resulting from packet losses, cannot be compensated for by transmitting the rejected packets once again. Since, in principle, these Quality of Service requirements apply to all networks using packet-oriented transmission, they are independent of the specific configuration of a packet-oriented network. The packets may, in consequence, be in the form of Internet, x.25 or frame-relay packets, or in the form of ATM cells.

In order to transmit voice and picture information via the packet-oriented Internet, also referred to as “VoIP”—the International Standards (in particular, the H.323 Standard) contain proposed protocols for transmission through the Internet. In this case, the network is broken down into a number of “H.323 zones”, in each of which “gatekeepers” are provided for
converting E.164 telephone numbers to computer names and/or to their Internet addresses,
permissibility checking for incoming and outgoing calls,
management of transmission capacities, and
registration of H.323 terminals.

Since, however, the present H.323 Standards do not include any guaranteed Qualities of Service for Internet transmission, the present VoIP technology has the disadvantage that the quality of voice and picture transmission decreases as the number of packets to be transmitted by the Internet rises. In this context, K. Nichols, “Differentiated Services Operational Model and Definitions”, IETF Draft, 1998 proposes that a number of service classes be introduced in the packet-oriented Internet, which previously did not guarantee any Qualities of Service. In this case, the individual packet streams are each allocated to a specific service class and are transmitted with high priority or low priority in comparison to packets in other service classes, depending on their service class, by the transmission nodes in the Internet. The Quality of Service required for realtime services can, thus, be guaranteed, for example, by allocating the associated realtime packet streams to a service class which is transmitted with high priority by the nodes in the Internet—the realtime packet streams are thus prioritized over the data packet streams.

In principle, network access monitoring is required at least for the prioritized traffic for priority-controlled transmission since the required Quality of Service can be guaranteed only when the number of prioritized packets supplied to the network is not greater than the maximum number which can be transmitted by the network. To this end, network gateway devices—also referred to as “edge devices”—have been proposed for the Internet with a number of service classes, and these devices provide the network access monitoring. In this case, the edge devices can
set priority tags in the packets depending on the priority of their packet streams,
monitor priority tags of packet streams and correct them if necessary, if the packets are already tagged with priorities, and
monitor the transmission capacity of prioritized packet streams.

Until now, there has been no control over the allocation of the Quality of Service; that is, there is a problem as to how Qualities of Service for the packet streams are requested, allocated and signaled to the edge devices before being transmitted. A method is known, in which a reservation protocol RSVP is used by each transmission node in a communications network, to request a Quality of Service required for the transmission of a packet stream, and in which the packet stream is not transmitted if at least one transmission node cannot provide the requested Quality of Service. In this case, the reservation protocol RSVP must be provided in each of the transmission nodes.

The present invention is thus directed toward designing a method for allocation of a Quality of Service for the transmission of a packet stream via a packet-oriented communications network with service classes.

### SUMMARY OF THE INVENTION

A major aspect of the present invention is the allocation of a Quality of Service for a service in which the service is provided in at least one communications network which transmits packets and/or packet streams in a packet-oriented manner as a function of Qualities of Service, use of the service is requested with a controller, and the controller allocates the Quality of Service for the requested use of the service as a function of the service and/or of the requested use of the service. A major advantage of the present invention is that the use of the service is requested rather than the allocation of a Quality of Service. The controller can thus allocate different Qualities of Service to the requested service, for example with a high Quality of Service if the transmission capacity in the communications network is sufficient, and with a low Quality of Service if the transmission capacity in the communications network is insufficient. Furthermore, the Quality of Service is advantageously allocated on a packet-stream-specific basis. This is a particular advantage if transmission with a guaranteed packet-stream-specific Quality of Service is not provided in the communications network.

According to an embodiment of the method according to the present invention, the use of the service is requested without stating the Quality of Service. There is, thus, no need to determine the Quality of Service when requesting use of the service.

According to another embodiment of the method according to the present invention, the service is in the form of transmission of information; in particular, voice information. In a further embodiment of the method, when the service is being used by the communications network, at least one packet stream which is allocated to the service is transmitted with the Quality of Service. The invention can, thus, preferably be used to satisfy particular Quality of Service requirements for the transmission of voice information via a packet-oriented communications network; in particular, an integrated voice/data network.

According to another embodiment of the present invention, the controller checks whether the requested use of the service can be provided with the intended Quality of Service by the communications network. The check is then carried out by the controller and not by the communications network, thus relieving the load on the communications network.

According to an embodiment of the method according to the present invention, the controller signals the Quality of Service of the packet stream to a network gateway device, before the network gateway device transmits the packet stream with its Quality of Service to the packet-oriented communications network. This advantageously leads to the packet stream being transmitted by the network gateway device with the allocated Quality of Service to the communications network.

According to another embodiment of the method according to the present invention, at least one acknowledgement of the signaled Quality of Service is required for the permissibility of the packet stream. This ensures that the packet stream is permissible only if the allocated Quality of Service can be transmitted. The signaling and subsequent acknowledgement of the Quality of Service can, thus, be integrated in the permissibility check, by which the permissibility check and the allocation of the Quality of Service can be carried out as a unit, that is to say consistently.

According to another embodiment of the method according to the present invention, the Quality of Service is signaled with the aid of signaling packets. The signal then can be transmitted in the same way that the packet stream is transmitted.

According to a further embodiment of the method according to the present invention, at least one high Quality of Service and one low Quality of Service are provided in the communications network. In this case, the present invention provides for the packet streams with a high Quality of Service to be transmitted with priority by the network gateway device. Packet streams which are intended for transmitting information in realtime, that is to say with delay times that are as short as possible, can thus be transmitted with priority over packet streams which can transmit information with variable delay times. Examples of information which are transmitted with a high Quality of Service are voice or video telephony. Examples of information which are transmitted with a low Quality of Service are E-mail, files or Internet pages.

According to another embodiment of the method according to the present invention, a Quality of Service tag is provided in the packets in the data streams. In this case, the network gateway device transmits those packet streams which are to be transmitted by it with a high Quality of Service with a first Quality of Service tag which represents the high Quality of Service, and transmits the remaining packet streams with a second Quality of Service tag, which represents the low Quality of Service. Transmitting the allocated Quality of Service in the packets in the data stream thus makes it possible, by reading the Quality of Service tag in the transmission node in the communications network, to determine the allocated Quality of Service while the packet stream is being transmitted, thus making it unnecessary to store the allocated Quality of Service in the transmission nodes.

According to an embodiment of the method according to the present invention, the Quality of Service is produced on the basis of priorities, with the high Quality of Service being stated as the high priority and the low Quality of Service being stated as the low priority, and the Quality of Service tag has been stated as the priority tag. The prioritized transmission of the packet streams with a high Quality of Service can thus be achieved in a simple manner via known mechanisms for priority control.

According to yet another embodiment of the method according to the present invention, the network gateway device is in the form of an edge device, the packets are in the form of Internet packets, and the controller is in the form of a gatekeeper in accordance with International Standard H.323. The method according to the present invention then can advantageously be introduced into the existing infrastructure of a modern Internet. Furthermore, the Quality of Service can be allocated as a function of the permissibility check by the gatekeeper.

Additional features and advantages of the present invention are described in, and will be apparent from, the following Detailed Description of the Invention and the Figures.

### BRIEF DESCRIPTION OF THE FIGURES

FIG. 1 shows a block diagram relating to the transmission of prioritized packet streams via a communications network with Qualities of Service in accordance with the teachings of the present invention.

FIG. 2 uses a flowchart to show the integration of the method according to the present invention in a transmission in accordance with International Standards H.323, H.225 and H.245.

### DETAILED DESCRIPTION OF THE INVENTION

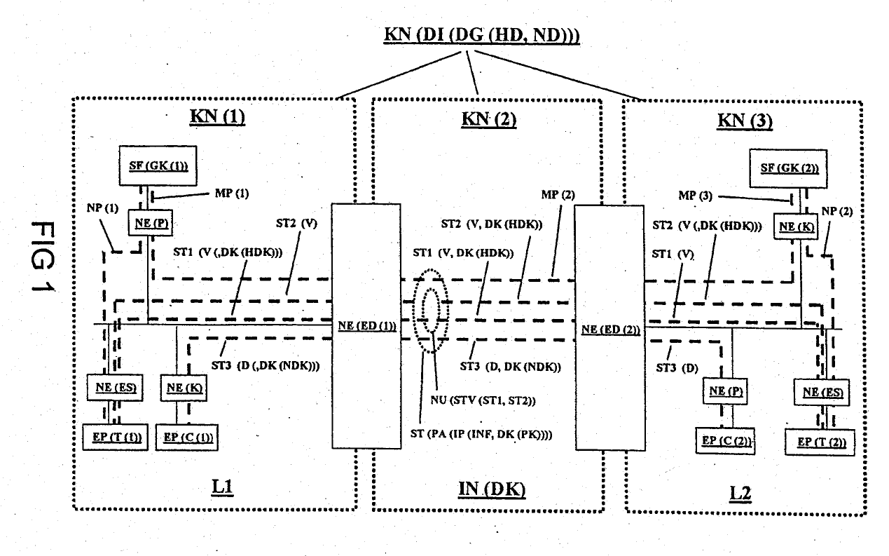

By way of example, FIG. 1 shows three communications networks KN which, for example, are in the form of packet-oriented, convergent voice/data networks. In this case, the first communications network KN (1) is referred to as the first local area network LAN L1, the second communications network KN (2) is the Internet IN, and the third communications network KN (3) is a second LAN L2. Packet streams ST which include a sequence of packets PA can be transmitted in the communications networks KN as a function of the Qualities of Service DG with at least one high Quality of Service HD and one low Quality of Service ND being provided in each case. The packets PA are used to transmit information INF which, for example, represents voice information V or data D. The communications networks KN are connected to one another via a network gateway device NE, with the Internet IN being connected by a first network gateway device NE (ED (1)) to the local area network L1 and by a second network gateway device NE (ED (2)) to the LAN L2, and with the network gateway device NE (ED (1)) in this case, for example, being in the form of a first edge device ED (1), and the network gateway device NE (ED (2)) being in the form of a second edge device ED (2). A first telephone T (1) and a first computer C (1) are also connected to the LAN L1, and a second telephone T (2) and a second computer C (2) are connected to the LAN L2, in both cases via network gateway devices NE which, for example, are in the form of plug-in cards K, electrical circuits ES or programs P. Voice information V is transmitted in voice packet streams STV between the two telephones T (1), T (2)—from the telephone T (1) to the telephone T (2) in a first packet stream ST1 and in the opposite direction in a second packet stream ST2 and data D is transmitted by a third packet stream ST3 from the computer C (1) to the computer C (2). At least in the Internet IN, the packets PA in this case have Quality of Service tags DK, which are in the form of Quality of Service tags HDK representing the high Quality of Service HD in the packets PA in the packet streams ST1, ST2, and are in the form of Quality of Service tags NDK which represent the low Quality of Service ND in the packets PA in the packet stream ST3. The Quality of Service tags DK are in this case, for example, in the form of priority tags PK. Furthermore, a controller SF is provided in each of the two LANs L1, L2 and, in accordance with the International VoIP Standard H.323, is in the form of a gatekeeper GK for controlling the transmission of voice information V, with a first gatekeeper GK (1) being arranged in the LAN L1 and a second gatekeeper GK (2) being arranged in the LAN L2, and with these gatekeepers being connected by network gateway devices NE to the respective LANs L1, L2. Signaling packets MP are interchanged between the gatekeepers GK and the edge devices ED, with first signaling packets M (1) being transmitted between the gatekeeper GK (1) and the network gateway device NE (ED (1)), second signaling packets MP (2) optionally being transmitted between the network gateway devices NE (ED (1)), NE (ED (2)), and third signaling packets M (3) being transmitted between the gatekeeper GK (2) and the network gateway device NE (ED (2)). Furthermore, service use packets NP are transmitted between the telephones T and the gatekeepers GK, with first service use packets NP (1) being transmitted between the telephone T (1) and the gatekeeper GK (1), and second service use packets NP (2) being transmitted between the telephone T (2) and the gatekeeper GK (2).

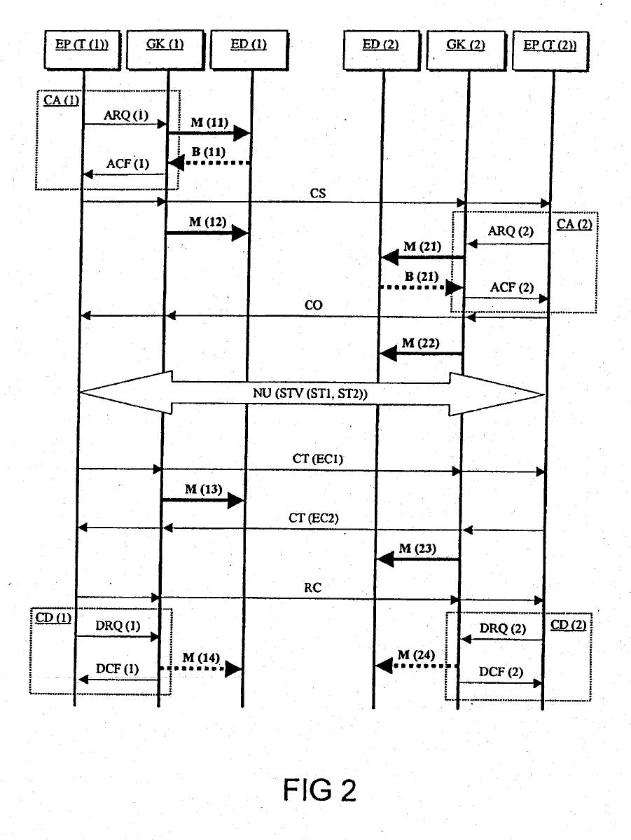

By way of example, FIG. 2 uses a flowchart to show the information interchange, which takes place when transmitting VoIP in accordance with VoIP Standards H.225 and H.245, between the end points EP which are in the form of telephones T (1) and T (2), the first gatekeeper GK (1) and the second gatekeeper GK (2), as well as the information interchange according to the present invention between the two gatekeepers GK (1), GK (2) and the two network gateway devices NE (ED (1)), NE (ED (2)), with signals M and acknowledgements B according to the present invention also being provided in accordance with VoIP Standards H.225 and H.245, in addition to the message interchange. In this case—preferably using the signaling packets MP (1)—a first signal M (11), a second signal M (12), a third signal M (13) and a fourth signal M (14) are transmitted from the gatekeeper GK (1) to the network gateway device NE (ED (1)), and a first acknowledgement B (11) is transmitted from the network gateway device NE (ED (1)) to the gatekeeper GK (1). Analogously—preferably with the signaling packets MN (3)—a fifth signal M (21), a sixth signal M (22), a seventh signal M (23) and an eighth signal M (24) are, according to the present invention, transmitted from the gatekeeper GK (2) to the network gateway device NE (ED (2)), and a second acknowledgement B (21) is transmitted from the network gateway device NE (ED (2)) to the gatekeeper GK (2).

For the exemplary embodiment, it is assumed that a number of Qualities of Service DG are provided, at least in the Internet IN, and are indicated to the Internet via the Quality of Service tag DK provided in the Internet packets IP. Furthermore, data D is already being transmitted by the computer C (1) to the computer C (2) via the packet stream ST3 with the low Quality of Service ND. It is now also intended to transmit voice information V between the two end points EP, for example the telephones T (1), T (2), and this is intended to be done at least via the Internet IN using a high Quality of Service HD. To this end, once a telephone number which is structured in accordance with the International Standard E.164 has been entered, the telephone T (1) requests a connection to the telephone T (2). This is also referred to as call admission CA. During the first call admission CA (1), the telephone T (1) makes a request in the LAN L1 to transmit the packet stream ST1 to the telephone T (2), by the telephone T (1) sending a first admission request message ARQ (1) to the gatekeeper GA (1). The gatekeeper GK (1) then translates at least the telephone number to the Internet address of the telephone T (2). According to the present invention, the gatekeeper GK (1) also assigns the high Quality of Service HD to the packet stream ST1 and signals this to the network gateway device NE (ED (1)) via the signal M (11). For example, a transmission capacity of 64 kbps could be requested. The gatekeeper GK (1) then transmits a first admission confirmation message ACF (1) to the telephone T (1), and this can, optionally, be done as a function of the acknowledgement B (11) sent back as the response from the network gateway device NE (ED (1)) to the gatekeeper GK (1). The telephone T (1) then initiates the process of setting up a connection to the telephone T (2) by sending to the telephone T (2) a call set-up message CS in accordance with the internationally standardized monitoring protocol H.225. In this case, inter alia, the protocol and port number of the telephone T (1) are also signaled to the gatekeeper GK (1), and are signaled by the gatekeeper GK (1) to the network gateway device NE (ED (1)) using the signal M (12).

Since, owing to the bidirectional character of a voice connection, two voice packet streams STV—the packet stream ST1 for transmission of the voice information V from the telephone T (1) to the telephone T (2), and the packet stream ST2 for transmitting the voice information V from the telephone T (2) to the telephone T (1)—are required, the telephone T (2) requests the packet stream ST2, once the call set-up message CS has been received. The packet stream ST2 is set up analogously to the setting up of the packet stream ST1. Following this, the telephone T (2) makes a second call admission CA (2), with the gatekeeper GK (2) signaling, once a second admission request message ARQ (2) has been received, the requested high Quality of Service HD to the network gateway device NE (ED (2)) via the signal M (21) according to the present invention. This could be acknowledged in an analogous manner using the acknowledgement B (21). The call admission CA is terminated by a second admission confirmation message ACF (2), following which the second telephone T (2) sends a connect message CO to the first telephone T (1). In order to complete the setting up of the connection, the protocol number and the port number of the telephone T (2) are signaled to the network gateway device NE (ED (2)) using the signal M (22). The voice information V is now transmitted with a high Quality of Service via the packet streams ST1, ST2 between the two telephones T (1), T (2); that is, the transmission takes place with priority over the transmission of the packet stream ST3 which is to be transmitted with the low Quality of Service ND.

After completion of the call, the telephone T (1), for example, initiates the clearing of the connection, also referred to as “End Session”, by sending to the telephone T (2) a first call teardown message CT (1) in accordance with International Standard H.245. Once this message has been received, at the earliest, the gatekeeper GK (1) can signal the clearing of the connection to the network gateway device NE (ED (1)) via the signal M (13) following which the reserved high Quality of Service HD could be enabled by the network gateway device NE (ED (1)). Once the first call teardown message CT (1) has been received, the telephone T (2) likewise sends a second call teardown message CT (2), in response to which the gatekeeper GK (2) could also send the signal M (23) to the network gateway device NE (ED (2)). The signals M (13), M (23) contain, for example, the Internet addresses and port numbers of the two telephones T (1) and T (2), protocol numbers and/or the transmission capacities required by the voice packet streams STV. After receiving the call teardown message CT (2), the telephone T (1) sends a release complete message RC, and then initiates a first call disengage CD (1), by transmitting a first disengage request message DRQ (1) to the gatekeeper GK (1). The gatekeeper GK (1) then uses the signal M (14) to signal to the network gateway device NE (ED (1)) the end of the transmission of the packet stream ST1, and the call disengage CD (1) is completed by sending a first disengage confirm message DCF (1). After receiving the release complete message RC, the telephone T (2) initiates a second call disengage CD (2) in an analogous manner by transmitting a second disengage request message DRQ (2) to the gatekeeper GK (2). The gatekeeper GK (2) then uses the signal M (24) to signal to the network gateway device NE (ED (2)) the end of the transmission of the packet stream ST2, and the call disengage CD (2) is completed by sending a second disengage confirm message DCF (2).

According to one variant of the present invention, the signaling packets MP (2) are used to signal the high Quality of Service HD of the packet stream ST1 to the network gateway device NE (ED (2)). The network gateway device NE (ED (2)) can then transmit the packet stream ST1 with priority; that is, both within the network gateway device NE (ED (2)) itself and, provided this is technically feasible in the LAN L2, by priority transmission to the LAN L2 and/or in the LAN L2.

According to a further variant of the present invention, the Qualities of Service DG are signaled to the network gateway devices NE (ED (1)), NE (ED (2)) and to the gatekeeper GK using a reservation protocol; for example, the reservation protocol RSVP.

Finally, it should be mentioned that the present invention is not restricted to an Internet IN, but can be used in any packet-oriented communications network KN with Qualities of Service DG. For example, use in local area networks L1, L2 is envisioned. This is indicated in FIG. 1 by the fact that the controllers SF, the computers C (1), C (2) and the telephones T (1), T (2) likewise access the local area networks L1, L2 using network gateway devices NE, in which case configuration of the network gateway device NE according to the present invention via the controllers SF allows prioritized transmission, that is to say transmission carried out with a high Quality of Service HD, of voice information V in the local area networks L1, L2.

Indeed, although the present invention has been described with reference to specific embodiments, those of skill in the art will recognize that changes may be made thereto without departing from the spirit and scope of the invention as set forth in the hereafter appended claims.

1-16. (canceled)

17. A method for allocating a Quality of Service for a service, which is provided in at least one communications network which transmits at least one of packets and packet streams in a packet-oriented manner as a function of Qualities of Service, the method comprising the steps of:
requesting, by a controller, use of the service; and
allocating, via the controller, the Quality of Service for the requested use of the service as a function of at least one of the service and the requested use of the service.

18. A method for allocating a Quality of Service for a service as claimed in claim 17, wherein the use of the service is requested without stating the Quality of Service.

19. A method for allocating a Quality of Service for a service as claimed in claim 17, wherein the service is the transmission of voice information.

20. A method for allocating a Quality of Service for a service as claimed in claim 17, the method further comprising the step of:
checking, via the controller, whether the requested use of the service can be provided with the intended Quality of Service by the communications network.

21. A method for allocating a Quality of Service for a service as claimed in claim 17, wherein, when the service is used by the communications network, at least one packet stream which is allocated to the service is transmitted with the Quality of Service.

22. A method for allocating a Quality of Service for a service as claimed in claim 21, the method further comprising the steps of:
signaling, via the controller, the Quality of Service of the packet stream to at least one network gateway device; and
transmitting, via the network gateway device, the packet stream with the signaled Quality of Service to the communications network.

23. A method for allocating a Quality of Service for a service as claimed in claim 22, wherein the network gateway device is an edge device.

24. A method for allocating a Quality of Service for a service as claimed in claim 22, the method further comprising the step of:
requiring at least one acknowledgement of the signaled Quality of Service for the allocation of the Quality of Service.

25. A method for allocating a Quality of Service for a service as claimed in claim 22, wherein the Quality of Service is signaled using signaling packets.

26. A method for allocating a Quality of Service for a service as claimed in claim 22, the method further comprising the step of:
providing at least one high Quality of Service in at least one low Quality of Service in the communications network.

27. A method for allocating a Quality of Service for a service as claimed in claim 26, wherein packet streams with the high Quality of Service are transmitted with priority by the network gateway device.
